(19) United States
(12) Patent Application Publication
(10) Pub. No.: US 2016/0107491 A1
(43) Pub. Date: Apr. 21, 2016

(54) AIR MAINTENANCE TIRE ASSEMBLY

(71) Applicant: The Goodyear Tire & Rubber Company, Akron, OH (US)

(72) Inventor: Cheng-Hsiung Lin, Hudson, OH (US)

(21) Appl. No.: 14/519,176

(22) Filed: Oct. 21, 2014

(51) Int. Cl. B60C 23/12; F04B 35/01; B60S 5/04; F04B 27/00

(52) U.S. Cl. CPC B60C 23/12; F04B 27/005; F04B 35/01; B60S 5/043

(57) ABSTRACT

A pumping assembly keeps a pneumatic tire from becoming underinflated. The pumping assembly includes an even number of pumps attached to the tire rim, a gravity mass for producing a pumping action, a cam fixed to the gravity mass for maintaining the cam in a fixed position relative to the gravity mass, and rollers for engaging the cam and producing the pumping action as the tire rim rotates and the gravity mass retards rotation of the cam as the tire rim rotates.

### FIELD OF THE INVENTION

The present invention generally relates to automotive and other vehicles, and more specifically, to a wheel for such a vehicle which includes a pump for automatically inflating a pneumatic tire mounted on the wheel.

### BACKGROUND OF THE INVENTION

Low tire pressure is a major cause of excessive fuel consumption, tire wear, and impaired steerability. A typical pneumatic tire will leak about 25 percent of its pressure per year due to rubber's inherent permeability. It is thus good practice to check/maintain tire pressure on a regular basis.

However, even checking tire pressure every few weeks may not prevent these adverse affects when a slow leak is present, and the leak may go undetected unless a careful record is maintained of how frequently the pressure in each tire has to be replenished. A fast leak or flat condition may rapidly cause damage to the tire and even render it unusable in a short period of time even though this condition may go unnoticed by an inexperienced driver until it is too late.

It is thus desirable to have some mechanism that automatically replenishes the tire pressure when it is lower than its optimal amount. Conventional tire pumps may be mounted on vehicle wheels and utilize centrifugal force to automatically pump air from the atmosphere into a tire cavity and thereby maintain the tire pressure at a predetermined value.

These pumps may be two-stage pumps with a piston radially movable in a cylinder to draw air from the atmosphere into a primary chamber and pump air from a secondary chamber into the tire cavity when the piston is moved outward by centrifugal force resulting from movement of the vehicle and rotation of the wheels. The piston may be moved inward by a spring when the vehicle stops to transfer air from the primary chamber into the secondary chamber. In order to keep the mass of the piston and the force and size of the spring within practical limits, the piston and spring may be made small enough that the piston may begin to move outward in response to a small centrifugal force resulting from a low vehicle speed.

This causes a problem when the vehicle is operated at low speed in the rain, and/or on terrain including loose particulate matter such as dirt or sand. If the pump does not have an inlet filter, operation under such adverse conditions may cause contaminants to be drawn into the pump and clog the inlet and outlet valves and/or even be pumped into the tire. If the pump does have an inlet filter, the filter may become clogged. These conditions may render the pump inoperable.

Friction between the piston and the wall of the cylinder when the pump is operating also may cause wear and reduction of the service life of the pump. Since pneumatic tires typically leak slowly, an automatic tire pump may only be required to operate during a fraction of the time the vehicle is running to maintain the pressure at the optimal value. Conventional tire pumps may operate continuously, and are thereby subjected to more wear than is necessary.

Another conventional pump may be mounted to a vehicle's wheel and be powered by the wheel's motion during normal vehicle operation thereby maintaining an optimal tire inflation pressure. The pump may be a positive displacement, piston-type compressor wherein the piston responds to the centrifugal force generated by the wheel's rotation or to the vertical acceleration generated by the wheel's response to bumps in the road. The piston may be a small diameter, but may include an upper extension made of dense material. Thus, there may be sufficient mass responding to rotation or the motion from bumps to move the piston and create the necessary pressure for inflation. The piston may be returned by a spring once the forces acting upon the piston decline due to a slow vehicle speed, a smooth driving surface, or both.

The pump may include inlet and outlet check valves. The pump/inflator may be mounted to the wheel either within the tire cavity or external to the tire. If the centrifugal forces of rotation are to propel the piston, the axis of the cylinder may be oriented radially. If the pump is designed to be energized by the wheel's reaction to bumps in the road, it may be oriented tangential to a circle centered at the wheel axis. It may also have a double acting piston. Compression would then take place when the compressor would be approximately at 3:00 o'clock or 9:00 o'clock in its rotation with the wheel as a bump would be hit by the wheel.

For the case of centrifugal force for piston action, there may be one compression stroke for each excursion of automobile speed from stationary or some minimum speed up to the automobile speed which translates into adequate rotational speed to generate the needed piston force to create air flow into the tire cavity. For the case in which bumps in the road actuate the piston, the compression strokes may be more random than the bumps themselves since the strokes would only occur when the axis of the compressor would be aligned in its rotation to a direction more or less parallel with the wheel motion caused by the bump.

Pressure regulation may be provided by designing the pump's compression ratio to limit the delivery pressure to that desired to be the maximum tire inflation pressure. Compression ratio may be the ratio of cylinder volume at the start of a piston stroke to the volume remaining in the cylinder at the end of the piston's stroke. Compression ratio for a given basic design may be set at the time of manufacture by either limiting the piston travel or by providing additional “dead” volume within the piston. One method for this may be to drill a hole in the bottom of the piston at the time of manufacture, the depth of the hole being set to obtain the desired pressure development.

When the pump is actuated by centrifugal force, the pump may work with the piston gradually progressing along the cylinder against the compressed charge of air in the cylinder as the vehicle accelerates and the wheel rotation rate increases. Once the charge of air exceeds the existing tire pressure plus the discharge valve cracking differential pressure, any increased vehicle speed causes additional stroke movement of the piston and discharge of the compressed air into the tire cavity. As the vehicle slows or stops, the piston return spring may have returned the piston to its location at the beginning of its stroke and the pumping process may begin again with new vehicle motion. With typical passenger car operation including many stops and starts, the pump may deliver a small charge of air each time the vehicle accelerates from a speed low enough to allow the piston return spring to return the piston to a speed high enough to force the piston to compress air and discharge compressed air into the tire cavity.

In order to maximize the force available for driving the piston to compress the air in the cylinder, the piston may have an enlarged end made of dense material. The enlarged end may be opposite the end of the piston that fits into the cylinder, with its diameter being larger than the piston diameter. The enlarged end may be constructed of brass, lead, and/or other high density material(s). This conventional pump may eliminate extra tire wear and fuel consumption caused by underinflated tires. Where only a small leak occurs, this pump may extend mileage before the tire becomes completely uninflated or flat.

### SUMMARY OF THE INVENTION

A pumping assembly in accordance with the present invention keeps a pneumatic tire from becoming underinflated. The pumping assembly includes an even number of pumps attached to the tire rim, a gravity mass for producing a pumping action, a cam fixed to the gravity mass for maintaining the cam in a fixed position relative to the gravity mass, and rollers for engaging the cam and producing the pumping action as the tire rim rotates and the gravity mass retards rotation of the cam as the tire rim rotates.

According to another aspect of the pumping assembly, an outlet for directing pressurized air into a valve stem of the pneumatic tire.

According to still another aspect of the pumping assembly, a filter is disposed adjacent the outlet.

According to yet another aspect of the pumping assembly, a filter is disposed adjacent the valve stem.

According to still another aspect of the pumping assembly, an adjustable pressure control valve determines the pressure of air entering a tire cavity of the pneumatic tire.

According to yet another aspect of the pumping assembly, the pumping assembly pumps pressurized air in a tire cavity of the pneumatic tire in either direction of rotation of the tire rim.

According to still another aspect of the pumping assembly, four pumps are mounted at 90 degree increments about the tire rim.

According to yet another aspect of the pumping assembly, each of the four pumps is connected in series with the other three pumps such that the pumping assembly produces an amplification effect wherein the outlet pressure of one pump becomes the inlet pressure of another pump.

According to still another aspect of the pumping assembly, each of the four pumps has a single chamber and a single predetermined compression ratio.

According to yet another aspect of the pumping assembly, the compression ratio of the pumping assembly is the predetermined compression ratio of each pump raised to the fourth power.

According to still another aspect of the pumping assembly, each of the four pumps has two chambers and a single predetermined compression ratio for each chamber.

According to yet another aspect of the pumping assembly, the compression ratio of the pumping assembly is the predetermined compression ratio of each chamber raised to the eighth power.

A method in accordance with the present invention maintains pressure within a pneumatic tire. The method includes the steps of: attaching an even number of pumps to a tire rim; producing a pumping action with a gravity mass; fixing a cam to the gravity mass for maintaining the cam in a fixed position relative to the gravity mass; interfacing the pumps and the cam with rollers, and rotating the tire rim and pumps such that the gravity mass and cam retards rotation of the cam as the tire rim rotates.

According to another aspect of the method, another step includes the step of directing pressurized air into a valve stem of the pneumatic tire from a filter and outlet of the pumping action.

According to yet another aspect of the method, another step includes the step of determining the pressure of air entering a tire cavity of the pneumatic tire by an adjustable pressure control valve.

According to still another aspect of the method, another step includes pumping pressurized air in a tire cavity of the pneumatic tire in either direction of rotation of the tire rim.

According to yet another aspect of the method, other steps include mounting four pumps 90 degree increments about the tire rim and connecting each of the four pumps in series with the other three pumps such that the pumps produce an amplification effect wherein the outlet pressure of one pump becomes the inlet pressure of another pump.

According to still another aspect of the method, each of the four pumps have a single chamber and a single predetermined compression ratio and the compression ratio of the four pumps combined is the predetermined compression ratio of each pump raised to the fourth power.

According to yet another aspect of the method, each of the four pumps has two chambers and a single predetermined compression ratio for each chamber.

According to still another aspect of the method, the compression ratio of the four pumps combined is the predetermined compression ratio of each chamber raised to the eighth power.

### BRIEF DESCRIPTION OF THE DRAWINGS

The present invention will be described by way of example and with reference to the accompanying drawings, in which:

FIG. 1 schematically shows part of an example assembly in accordance with the present invention.

FIG. 2 schematically shows part of another example assembly in accordance with the present invention.

FIG. 3 schematically shows part of still another example assembly in accordance with the present invention.

FIG. 4 schematically shows yet another example assembly in accordance with the present invention.

FIG. 5 schematically shows the operation of the example assembly of FIG. 4.

FIG. 6 schematically shows an example cam for use with the example assembly of FIG. 4.

FIG. 7 schematically shows operation of part of the assembly FIG. 4.

FIG. 8 schematically demonstrates the functioning of an example assembly in accordance with the present invention.

### DETAILED DESCRIPTION OF EXAMPLES OF THE PRESENT INVENTION

An assembly 100 in accordance with the present invention defines a multi-chamber on-wheel air maintenance tire (AMT) pump design for an external wheel mounting. The assembly 100 may provide a low profile and effective AMT pump system easily and externally mounted to a standard wheel without significant modification of to the standard wheel. Further, the assembly introduce no issue when mounting a conventional tire to the wheel.

The assembly 100 may comprise an even number of pumps evenly distributed about the interior outside surface of the wheel in order to obtain the low profile and a well-balanced wheel. Single chamber or double chamber pumps may be used at each of the evenly distributed pump positions. Multiple pumps, serially connected to each other, may be used to create an equivalent multi-chamber effect.

An unbalanced mass and an axially uniform cam may be used to drive the pumps of the assembly 100. A relatively small roller may be used for pump/cam interaction. The unbalanced mass may be mounted with extra low friction bearings to ensure free rotation (low resistance) for the cam. Pumps and pump housings may be fixed to, and rotate with, the wheel. The unbalanced mass may be maintained at a vertical position due to gravity and low bearing friction, regardless of any rotational position of the wheel. These elements may define a stroke control multi-chamber pump system, such as the assembly 100.

Each chamber of each pump may represent one segment of the conventional vein system, such as set forth in U.S. Pat. No. 8,113,254 incorporated in its entirety herein by reference. A reservoir chamber may be added to the assembly 100 for absorbing rapid pressure losses to the tire cavity. An even number (e.g., 2, 4, 6, 8, etc.) of pumps and pump holders may be pre-assembled and placed evenly on a mounting plate that may then be assembled to the cam/unbalanced mass system described above. Mechanical or electronic control valve/pressure sensing may be used as a pressure/flow control unit. Pressure may be controlled at the ambient air inlet or pressurized outlet to the assembly 100. The air inlet may include a filter to prevent foreign items from being inlet to the pump system and blocking the pump system.

The outlet from the pump system may directly connect to a modified tire valve stem. This modified valve stem may retain its normal function (e.g., filling the tire cavity by air pump, deflating the tire for tire service, tire pressure measurement, etc.). The filter may alternatively be placed at the air outlet to the tire cavity. As with the conventional vein system, the assembly 100 may be independent of the direction of rotation of the tire. An adjustable pressure control valve may also easily fit into this assembly.

The low profile nature of the assembly 100 may allow the assembly to be directly mounted bolt pattern of the wheel hub. The assembly 100 thereby does not interfere with tire mount/dismount and provides a simple installation for the assembly, such as after-market addition of the assembly to a vehicle. As described above, the assembly 100 may function bi-directionally, regardless of the direction of rotation of the wheel/tire. Further, the installation direction will have no effect on pumping performance.

The assembly 100 may provide a relatively high compression ratio and a relatively high pumping capacity due to amplification effect of the serially mounted pumps. The pumping rate may be linear through most of pressure range of the assembly 100.

Due to an amplification effect of the assembly 100, compression may be defined as:

R=(r)ⁿ

where

R: assembly compression ratio

r: single chamber compression ratio

n: total number of chambers in the assembly

Therefore, a high compression ratio for each single chamber may not be required (e.g., low force or deformation required, etc.).

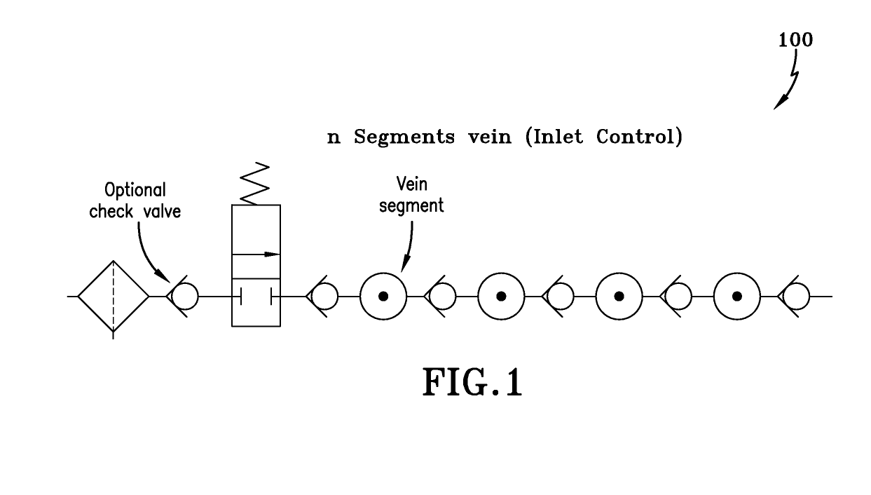

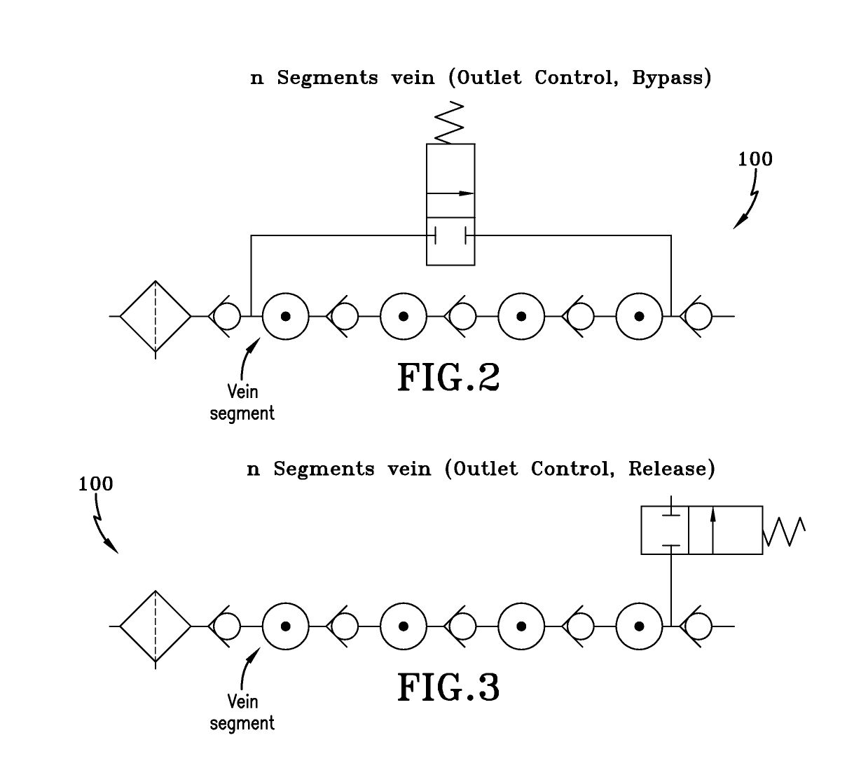

As the example assemblies of FIGS. 1-3 show, the assembly 100 may thus produce a staggered air pressure amplifier effect that may be used to overcome low pumping force created by gravity. Each chamber may represent two segments of vein system that generates small pressure differential (10 to 15 psi) for the next pump unit (e.g., staggered amplifier). This amplifier assembly 100 may generate 150 psi air from standard 90 psi air source.

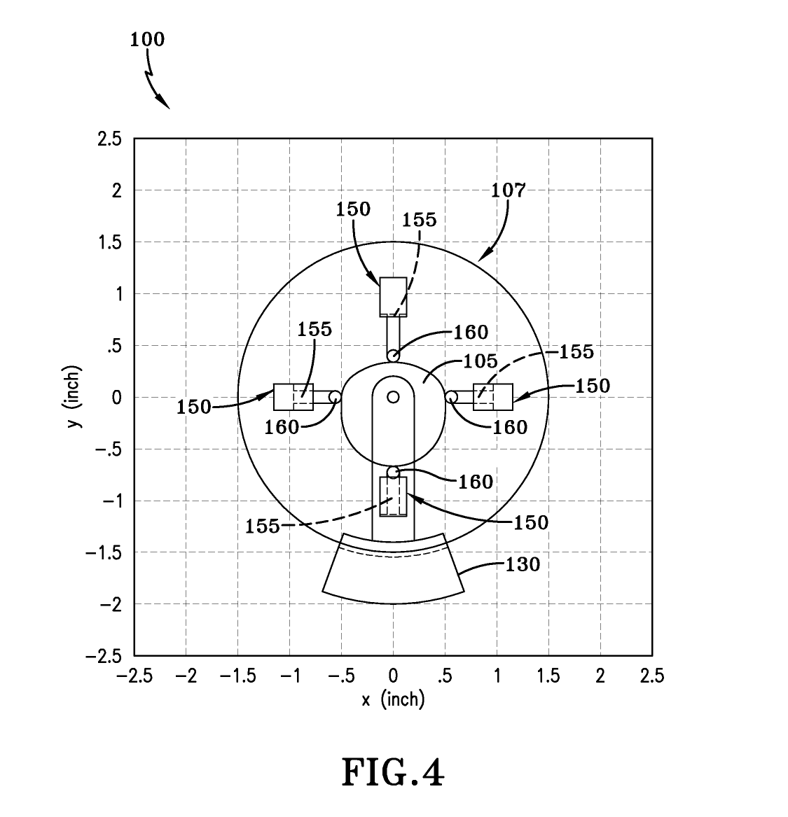

The assembly 100 may use a single piston for two chambers (not shown) or two, four (FIG. 4), six, eight, etc. single chamber pumps 150 for producing a controllable/dependent pressure differential between two chambers. The pump action may be based on displacement control (e.g., a cam 105 controlling stroke length). The source pressure of each chamber may be the chamber pressure of the previous chamber. The actuating mechanism of the pistons 155 may be a low resistance rotatable, unbalanced cam 105 with a rotating pump. A heavy mass 130 may be fixed relative to ground as the tire/wheel 107 rotates due to torque balance between the mass 130 and pump generated resistance (e.g., friction of pump rollers 160 and bearings). The assembly 100 may pump at lower efficiency as long as the unbalanced mass rotates at a speed different than the tire/wheel rotation.

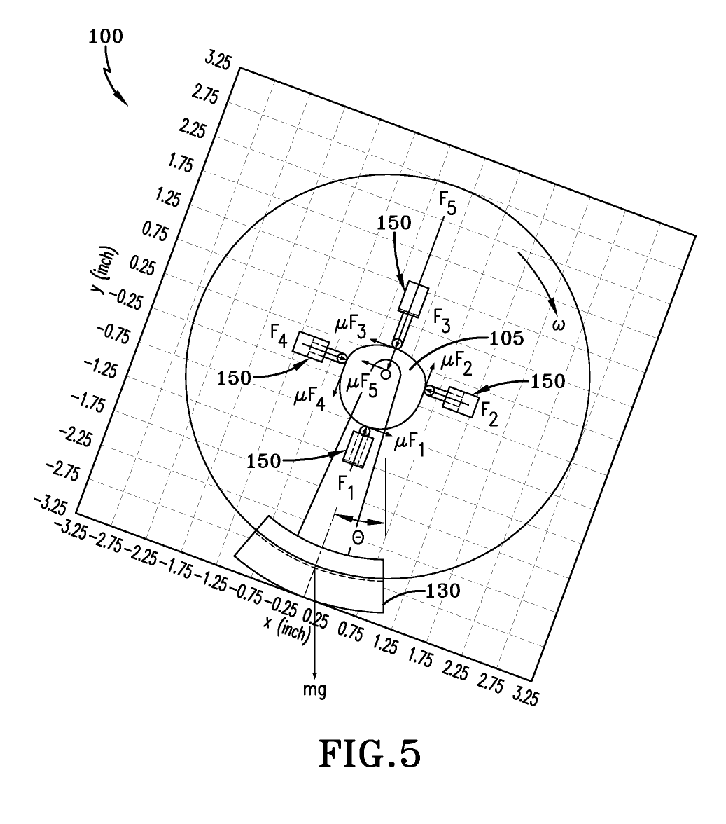

FIG. 5 defines force distribution of the assembly 100. F₁, F₂, F₃, and F₄ may be generated by the chamber pressures of the pumps 150. If the mass m or 130 does not rotate with the tire/wheel 107 (e.g., Θ is a constant because lack of torque to move mass 130), ω=0 and F₅=mg (cos Θ). Rmg (sin Θ)=r_{b}μF₅+r₁μF₁+r₂μF₂+r₃μF₃+r₄μF₄ to obtain Θ where −π/2<Θ<π/2. If m rotates coincidentally with the tire/wheel 107, Θ is not constant and F5=mR\acute{ω}₂, r_{b}μF₅+r₁μF₁+r₂μF₂+r₃μF₃+r₄μF₄>Rmg (sin Θ) for any Θ, and, therefore, r_{b}μF₅+r₁μF₁+r₂μF₂+r₃μF₃+r₄μF₄>Rmg.

The cam 105 may be designed for external on-wheel attachment by considering 0-180 degrees in any potential form. Based on required stroke length, equal distance from the cam 105 to the center at 0 degrees and 180 degrees (e.g. R_{avg}), 90 degrees may be as a maximum (or minimum) distance from the cam center (maximum or minimum radius, Rₘₐₓ or Rₘᵢₙ) as long as the slope at 0, 90, and 180 degrees is perpendicular to either axis x or y. Stroke Length may equal 2 (R_{avg}−Rₘᵢₙ) or 2 (Rₘₐₓ−R_{avg}) based on the form selected to determine R(Θ), 0≦Θ≦180. The distance for 180 to 360 degrees may be based on R(Θ)=2 R_{avg}−R(Θ−180). For example, if Stroke Length=8.5725 mm, R_{avg}=14.2875 mm (0.563″) and Rmin=10.00125 mm (0.394″). R may be defined as a half ellipse with long axis equal to 2 R_{avg} and short axis equal to 2 Rₘᵢₙ. Thus,

R(Θ)=R_{avg}Rmin/√(Rₘᵢₙ(cos Θ)²+R_{avg}(sin Θ)²) when 0≦Θ≦π

and

R(Θ)=2Ravg−R(Θ−π) when π≦Θ2π.

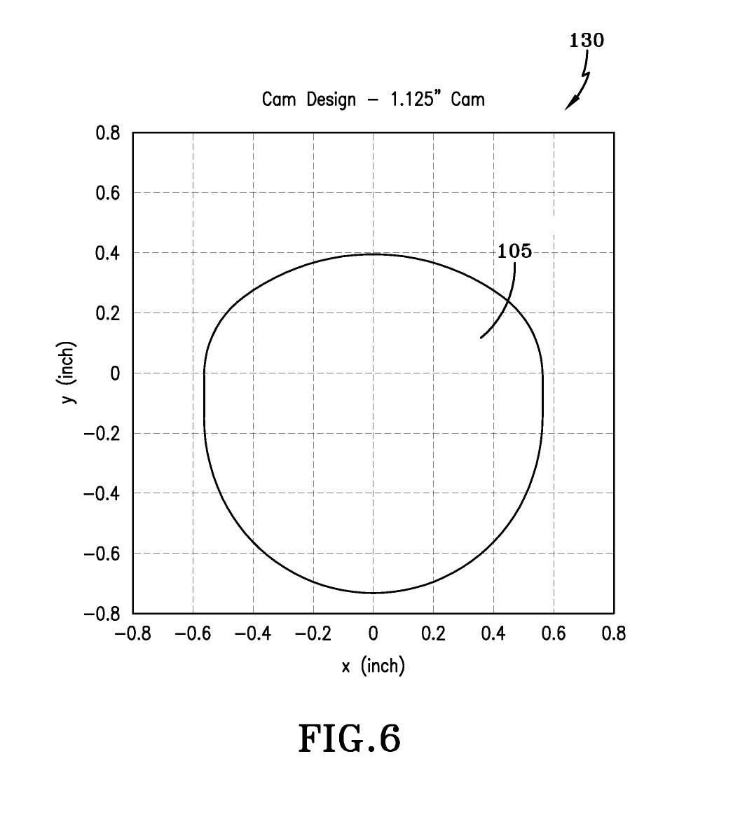

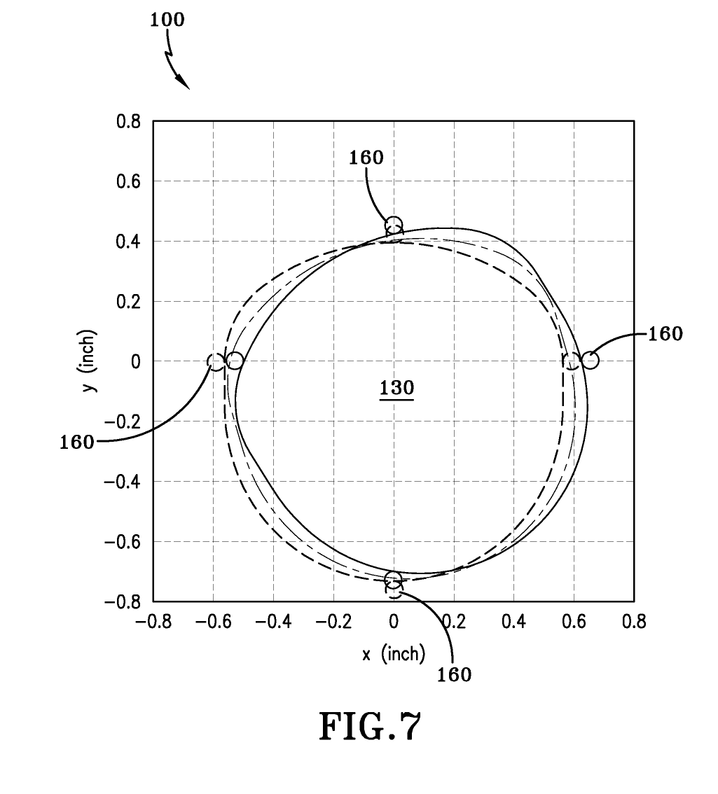

FIG. 6 shows an example 1.125″ cam. In FIG. 7, four pistons 155 with rollers 160 contact the example cam 130. As a result, two pairs of pistons 155 act against the cam 130.

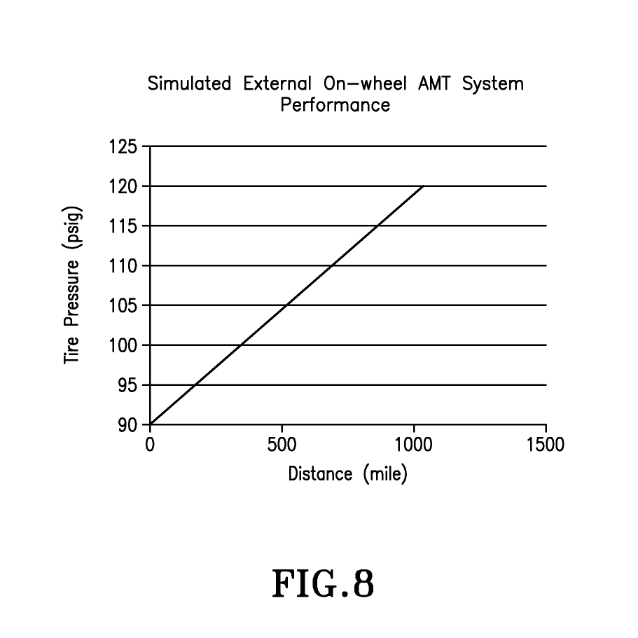

Based on one example miniature piston with double chambers, an Active Pump Volume may equal 271.5 mm³. Such an assembly 100 may have a pump rate of 2.92 psi per 100 miles, regardless of load. Wheel rotation direction may not affect pumping performance. A very small torque may be incurred at the pump rollers 160. If FIG. 8, an example torque is shown versus number of wheel rotations.

While a certain representative examples and details have been shown for the purpose of illustrating the present invention, it will be apparent to those skilled in the art that various changes and modifications may be made therein without departing from the spirit or scope of the present invention.

What is claimed:

1. A pumping assembly for use with a pneumatic tire mounted on a tire rim to keep the pneumatic tire from becoming underinflated, the pumping assembly comprising:
an even number of pumps attached to the tire rim;
a gravity mass for producing a pumping action;
a cam fixed to the gravity mass for maintaining the cam in a fixed position relative to the gravity mass; and
rollers for engaging the cam and producing the pumping action as the tire rim rotates and the gravity mass retards rotation of the cam as the tire rim rotates.

2. The pumping assembly as set forth in claim 1 further including an outlet for directing pressurized air into a valve stem of the pneumatic tire.

3. The pumping assembly as set forth in claim 2 further including a filter disposed adjacent the outlet.

4. The pumping assembly as set forth in claim 2 further including a filter disposed adjacent the valve stem.

5. The pumping assembly as set forth in claim 1 further including an adjustable pressure control valve for determining the pressure of air entering a tire cavity of the pneumatic tire.

6. The pumping assembly as set forth in claim 1 wherein the pumping assembly pumps pressurized air in a tire cavity of the pneumatic tire in either direction of rotation of the tire rim.

7. The pumping assembly as set forth in claim 1 wherein four pumps are mounted at 90 degree increments about the tire rim.

8. The pumping assembly as set forth in claim 7 wherein each of the four pumps is connected in series with the other three pumps such that the pumping assembly produces an amplification effect wherein the outlet pressure of one pump becomes the inlet pressure of another pump.

9. The pumping assembly as set forth in claim 8 each of the four pumps has a single chamber and a single predetermined compression ratio.

10. The pumping assembly as set forth in claim 9 wherein the compression ratio of the pumping assembly is the predetermined compression ratio of each pump raised to the fourth power.

11. The pumping assembly as set forth in claim 8 wherein each of the four pumps has two chambers and a single predetermined compression ratio for each chamber.

12. The pumping assembly as set forth in claim 11 wherein the compression ratio of the pumping assembly is the predetermined compression ratio of each chamber raised to the eighth power.

13. A method for maintaining pressure within a pneumatic tire, the method comprising the steps of:
attaching an even number of pumps to a tire rim;
producing a pumping action with a gravity mass;
fixing a cam to the gravity mass for maintaining the cam in a fixed position relative to the gravity mass; and
interfacing the pumps and the cam with rollers,
rotating the tire rim and pumps such that the gravity mass and cam retards rotation of the cam as the tire rim rotates.

14. The method as set forth in claim 13 further including the step of directing pressurized air into a valve stem of the pneumatic tire from a filter and outlet of the pumping action.

15. The method as set forth in claim 14 further including the step of determining the pressure of air entering a tire cavity of the pneumatic tire by an adjustable pressure control valve.

16. The method as set forth in claim 15 further including the step of pumping pressurized air in a tire cavity of the pneumatic tire in either direction of rotation of the tire rim.

17. The method as set forth in claim 16 further including the steps of:
mounting four pumps 90 degree increments about the tire rim; and
connecting each of the four pumps in series with the other three pumps such that the pumps produce an amplification effect wherein the outlet pressure of one pump becomes the inlet pressure of another pump.

18. The method as set forth in claim 17 each of the four pumps has a single chamber and a single predetermined compression ratio and the compression ratio of the four pumps combined is the predetermined compression ratio of each pump raised to the fourth power.

19. The method as set forth in claim 13 wherein each of the four pumps has two chambers and a single predetermined compression ratio for each chamber.

20. The method as set forth in claim 19 wherein the compression ratio of the four pumps combined is the predetermined compression ratio of each chamber raised to the eighth power.
